(19) United States
(12) Patent Application Publication
(10) Pub. No.: US 2011/0106738 A1
(43) Pub. Date: May 5, 2011

(54) SYSTEM AND METHOD FOR MANAGING IMPLEMENTATIONS

(76) Inventor: MARIANNA CHEKLIN, Sydney (AU)

(21) Appl. No.: 12/608,021

(22) Filed: Oct. 29, 2009

(51) Int. Cl. G06F 15/18; G06N 5/02; G06Q 10/00; G06Q 20/00; G06Q 99/00

(52) U.S. Cl. 706/14; 706/47; 705/301

(57) ABSTRACT

A system and method for managing implementations comprising real-time implementation decisions based on configuration rules and real-time events. The method ensures organizational-level control over implementation configuration. The method further facilitates prioritization of implementations based on organizational criteria. In real-time decision is based on configured rules, and provides a flexible yet consistent approach to implementation. The method facilitates communication throughout the implementation by allowing multiple concurrent modes of communication among implementation users, and between users and the system. Continuous improvement is facilitated by incorporating management of lessons learned, and by including recommendations for current implementation based statistics from prior decisions and from lessons learned.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but in all other circumstances reserves all copyright rights whatsoever.

### FIELD OF THE INVENTION

The invention disclosed herein relates generally to a system of implementation management and control.

### BACKGROUND

The present invention can most readily be understood by considering the detailed embodiments presented herein, but is not limited to the examples presented. Nor is the invention limited by samples of how it overcomes shortfalls in current methods. Some of the embodiments are presented in the context of an organization using a computerized system to facilitate carrying out the invention processes. In the following description of the embodiments of the invention, reference is made to the accompanying drawings that form a part hereof, and in which is shown by way of illustration, exemplary embodiments in which the invention may be practiced. It is to be understood that other embodiments may be utilized and structural changes may be made without departing from the scope of the present invention. These embodiments are examples only. The invention can be applied to any organization type, and in any type of implementation.

Some terms used throughout the description should be understood.

This invention applies in any implementation environment. The term implementation and this invention may apply to any type of implementation. Implementation is defined as any type of execution or enactment following on from initial planning. Software deployment into a production environment is one example; another example is deployment of hardware into a disaster recovery environment. But the invention application is not limited to software and hardware implementation. It can as easily be used to implement the construction of a building.

The term organization is typically referring to a functional organization such as, but not limited to, an incorporated company.

A module refers to a group of related activities or processes involved in carrying out embodiments of the invention.

A configuration item is an item being changed, added to, dismantled, removed, or migrated during the implementation.

A mode is a phase of operation involved in the carrying out embodiments of the invention.

Drop-dead time defined at the time and date by which a task, or the implementation overall, must be completed to prevent negative impact from the implementation. For instance, an implementation outage window may be granted to an implementation over a weekend to prevent business impact during working days. It may be agreed between the implementation team and the business that the drop-dead time is eight am on a particular Monday morning, meaning that the entire implementation must be complete, including rollback prior to that time. If that drop-dead time is missed, then business is impacted negatively, for instance, by not having access to a system. A drop-dead threshold time may be set, for instance, at the drop-dead time minus the time it takes to rollback. Once that time is reached, for instance, a decision to rollback may be made to prevent business impact.

Time, in this explanation of the invention, refers to both date and time boundaries.

Roles refer to groups of users, or another process, with particular access, and with a particular function, used to carry out embodiments of this invention.

### SUMMARY

In accordance with one embodiment this invention is a system and method for managing implementations comprising real-time implementation decisions based on configuration rules and real-time events.

### BRIEF DESCRIPTION OF THE DRAWINGS

FIG. 1a illustrates Administration Mode (AM), used to set up implementations across the organization, and Configuration Mode, used to set up individual implementations.

FIG. 1b illustrates Live Mode (LM) and Post Implementation Mode (PIM) of the implementation.

FIG. 2 illustrates hardware used in an example computer implemented embodiment of the invention.

FIG. 3 illustrates the risk and issue management, and example alternative implementation path options.

FIG. 4 illustrated the prioritization of an implementation.

### DETAILED SPECIFICATIONS

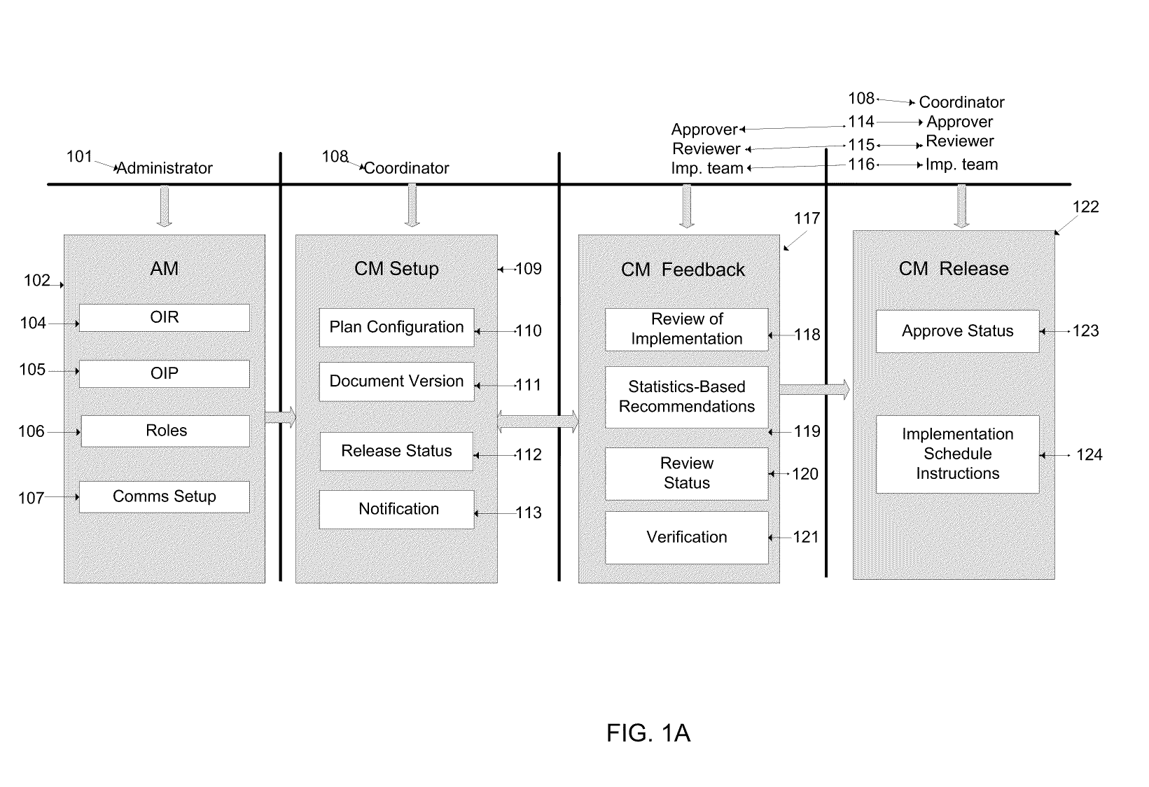

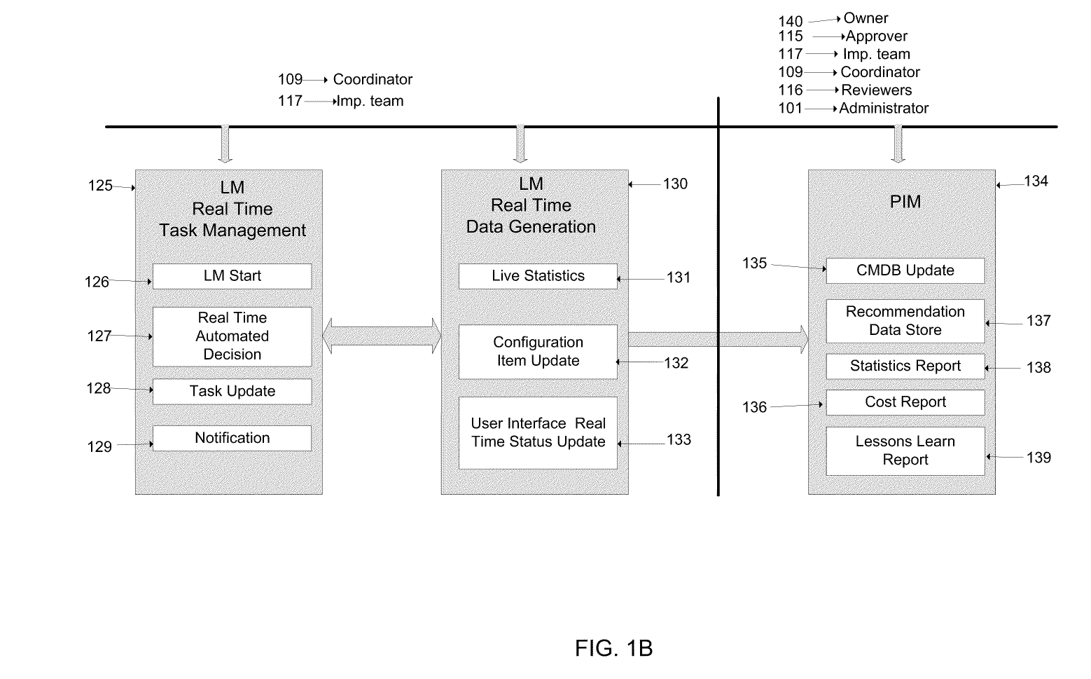

FIG. 1A and FIG. 1B together demonstrate the life-cycle of one embodiment of the invention. In FIG. 1A and FIG. 1B, directional arrows identify general flow of the processes of this embodiment of the invention, in addition to the general flow of data between various modules and data stores. This diagram only intended to show a high level example of the embodiment. In a practical system, other flows may exist, and phases may be repeated, or completed in a different fashion. The diagrams FIG. 1A and FIG. 1B, are not intended to illustrate compulsory modules in the system, but show only typical examples.

FIG. 1A and FIG. 1B, together illustrate a block diagram presenting a method for end-to-end high level processes according to one embodiment of the present invention.

In accordance with the embodiment of FIG. 1A, the method comprises the Administration Mode (AM) 102 in which organization-wide confines: or boundaries, as they apply implementations, are set. AM 102 is typically performed by the role of Administrator 101, though multiple, and more granular roles can be defined. For instance, a role can be created to administer only one module in the AM 102. Administration Mode (AM) 102, in this embodiment may comprise the modules Organization-wide rules (OIR) 104, Organization-wide prioritization (OIP) 105, Roles definition 106, and Communications setup 107.

AM 102 module OIR 104 in accordance with the embodiment of the present invention of FIG. 1A, is the module representing the process for defining implementation rules which apply to any implementation within an organization. These organization-wide rules encompass any configuration which may be done for an individual implementation. The types of rules may be, but are not limited to: mandatory task inclusion, cost-based rules, mandatory task timing, mandatory task types, escalation policy, drop-dead time rules, workaround mandatory tasks and rules, rollback mandatory tasks and rules, mandatory roles, mandatory approval rules, risk rules, workaround rules, rollback rules, statistics-based recommendations rules, and level of statistical data gathering and logging. The rules would be set by individuals with the role of Administrator, whose access to the system would cover any organization-wide configuration (AM 102), and whose function would be to perform organization-wide configuration. In some embodiments, OIR 102 may define particular conditions applying to a particular sub-organization function such as a department. Some embodiments of OIR 102 may define particular conditions which apply to an implementation categories, the type being defined by the organization.

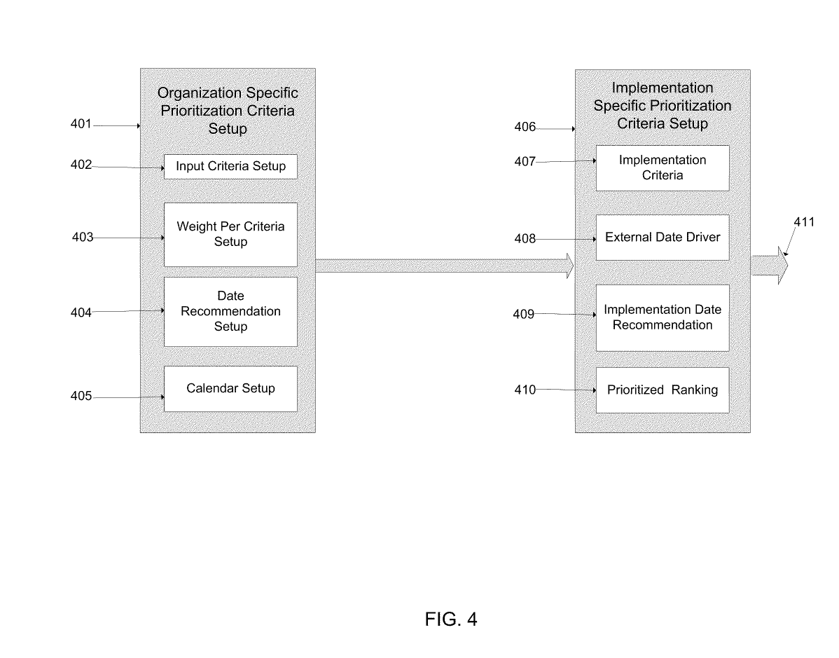

AM 102 module OIP 105 in accordance with the embodiment of the present invention of FIG. 1A, is the module representing the process for defining organization-wide (or department-wide) implementation priorities, which is further detailed in diagram 4. As per FIG. 4, the OIP module comprises two parts for convenience of explanation, the Organization Specific Prioritization Criteria Setup 401, Implementation Specific Prioritization Criteria Setup 406. 401 is the process where, first, the Input Criteria Setup 402 defines the criteria questions, the basis upon which the implementation will be prioritized. One example of input criteria for prioritization may be return on investment. Higher return on investment would mean higher priority on a scale. In addition, each Input criteria setup item 402, would also have a Weight per criteria setup 403, where each criteria is awarded a relative weighting to other input criteria on a scale. The OIP 105 FIG. 1A may also provide a date recommendation for implementation. In FIG. 4, Date recommendation setup 404 sets the criteria for date recommendation. Sample date recommendation criteria may be, but is not limited to: system outages, supplier date limitations, calendar limitations such as public holidays or staff leave, prioritization of the implementation. The Calendar setup 405 sets the calendar for implementation by configuring the calendar to which the implementation applies. There may be more than one calendar, and each calendar can use multiple time zones. Working days may be defined, time zones, and rules such as those around shift work. Implementation team resources may also be allocated to time zones.

Once the criteria for implementation prioritization is complete, as per 401, this is input into Implementation specific prioritization criteria setup 406, which is the setup of individual implementation prioritization and date recommendation based on input conditions from 401. 407 involves the completion of the Implementation criteria, where the questions defined in 402 are answers for the particular implementation, which in turn leads to Prioritized ranking 410. The output from OIP in this embodiment, as per 411, is date input into the CM 109 Plan configuration 110.

The calendar may use input in the form of, but not limited to: resource, supplier and customer availability, as per External date driver 408. The calendar may then be used as a factor in determining the date recommendation for implementation 409.

In accordance with the embodiment of FIG. 1A, Roles 106 module is the process where all implementation roles throughout the organization are defined. This can interface with an existing organizational structure and in the computer system embodiment of this invention; the roles may be based on organization hierarchy input files. The roles include access to any mode, module, or sub-module. In the computer system embodiment of this invention, the roles may be reined to screen and file access. Roles may define and group functions within the implementation to which individuals or other processes may be assigned. Another process may perform a role.

In accordance with the embodiment of FIG. 1A, Communications Setup 107 module is the process for defining the modes of communication in an implementation. In the computer system embodiment of this invention, accepted methods of communication may be any combination, but are not limited to: telephone, online via the system graphical user interface, sms, email, chat room.

For a single communication, a number of communication modes may be used, but this defined both in the OIR 104 and CM Plan Configuration 110. It is in here that conditional communication mode is set up, for instance rules where escalations, for example, must have mandatory communication modes of one sort, and a particular resource may use other forms of communication mode.

In accordance with the embodiment of FIG. 1A, the AM 102 organization-wide configuration, is input into Configuration Mode (CM) 109, in which the configuration for the specific implementation is performed, typically by the Coordinator role 108.

In accordance with the embodiment of FIG. 1A, the Configuration Mode (CM) is divided into three components in the diagram to facilitate explanation. CM Setup 109, where a specific implementation configuration is defined CM Feedback 117, which represents the feedback and verification cycle, and CM Release 122, in which the approval is gained to move to advance to the next mode, Live Mode, which is typified in FIG. 1B, LM Real-time Task Management 125.

Plan Configuration 110 module is the process for all individual implementation configuration, which includes configuring all tasks and rules pertaining to an individual implementation. This includes but is not limited to: task creation, task assignment to resources, setting tolerances for warnings, notifications and alternative paths in tasks, setting planned start and end time for tasks, setting risks per task and per implementation, defining drop-dead time for tasks and for implementation overall, defining escalation rules, defining contacts, contacts contact details, contacts mode of communication if different to default set in Comms Setup 107, workaround tasks, rollback tasks, cost-based rules, drop-dead date-time and drop-dead time rules, notification rules, configuration item register, linking configuration item to task/s, inclusion of external information such as change request numbers which relate to the implementation or specific tasks, defining task types, defining task prerequisites, defining task implementation details, defining task status. The Plan Configuration 110 uses rules defined in the OIR 104 as a basis. Plan Configuration process 110 cannot override OIR 104. In one computer system embodiment of this invention, automatic calculations of timing could be made during configuration 110, for instance but not limited to, calculating actions based on drop-dead time.

In accordance with the embodiment of FIG. 1A, Version Control 111 is a process which provides version control for implementation plans. Version control means automated increment in version once a change is made, check-in and check-out functionality to ensure data integrity of the implementation plan, and rollback to prior versions if required, in a typical embodiment, though other version control functionality may be applied. In addition, entire implementation configurations may be copied via this process so that a new implementation. Multiple configuration templates may also be created, so that individual configurations may be reused.

In accordance with the embodiment of FIG. 1A, Release Status 112 is the process which defines the configuration as ready for review. This can be accompanied by Notification 119, the rules of which are defined in Comms Setup 107.

In status of the individual implementation configuration. Typical release statuses include but are not limited to: Plan Status 112 where a configuration is not yet ready for review, Review Status 120 where a configuration is released for review, Approval Status which request further review or approval from the approvers, and approved status which is input into live mode.

In accordance with the embodiment of FIG. 1A, CM Feedback 117 comprises Review of Implementation 118, which is a process where, after the implementation configuration is released for review, feedback is provided from Review 115 role. The review of implementation includes notifications between the Coordinator who puts the plan together, the Reviewer role 115 whose task it is to review the implementation plan (who may also be an Approver 114) and Implementation Team 116. When a configuration draft is put into Release status, Reviewers are typically notified as well as the implementation team members. The review process is one where review is recorded in a central location visible to all Reviewers and Implementation Team members. Once the Reviews are collated, the configuration goes into draft mode where the implementation is checked out, and versioned up. Once the feedback from reviewers is incorporated, the configuration is released again. The configuration then repeats this process until all Reviewers mark their consent to request approval, and the configuration going into Reviewed status 120, with notification made to Approvers 114, Reviewers 115, Coordinators 108 and the Implementation Team 116. Other roles may also receive notification, for instance, some roles may have read-only access and receive notification. In a computer system embodiment of this system, the reviews comments may be stored in a central data store, and visible via a graphical user interface (GUI) by the relevant roles. Notifications may be sent by electronic means such as, but not limited to, email or sms as well as GUI on-screen notification. Status and approval would also be marked electronically, for example, but not limited to, a graphical user interface or email or sms.

In accordance with the embodiment of FIG. 1A, an additional part of the CM Feedback 117 process, Statistics-Based Recommendations 119 may be made. The OIR 104 process defines the level of statistics gathering, whether Statistics-based Recommendations are turned on, and configuration of Statistics-based Recommendations. OIR can configure under what level and type of similarity with past implementation the current implementation configuration recommendations are based on. This facilitates continual improvement in the implementation process. In one computer system embodiment of this invention, Statistics may be stored in a data store; configuration for statistics-based recommendation as a result of OIR 104 may also be stored in a central data store. These data stores may be used to prompt decisions as new tasks are created during the Plan Configuration as a form of feedback, which manifest as any combination prompts on the user interface, email, or other notification method set up in Comms Setup 107. The Coordinator may accept the recommendation, or reject it. The OIR 104 may mark some recommendations as mandatory.

In accordance with the embodiment of FIG. 1A, yet another component of the CM Feedback 117 process, Verification 121 is the module where the all aspects of the configuration, including tasks, timing, task links and notifications may be tested and verified prior to live implementation and approval. This process typically checks that all tasks have links that all timing is accurate, particularly taking into account drop-dead time and other dependencies, and resource availability. Verification would also include ensuring there is no missing data, that no mandatory OIR 104 elements are missing or not configured. In addition, it is possible to simulate implementation scenarios such as failure of a task, and task timing overruns. Notification is sent to the Coordinators 108 to inform them of outcomes. In the computer system embodiment of this invention, Verification process may include a data store of all configurations. The computer system would automatically verify each component of the implementation and send appropriate.

In accordance with the embodiment of FIG. 1A, In CM feedback 117, if a change to the implementation configuration draft is made such as a new version, a notification is sent out. This notification may include details of the changed information comparing the old and new versions of the configuration and displaying differences in the notification. In the computer system embodiment of this invention, the notification would happen automatically based on Comms Setup 107 and OIR 104. One example would be where an additional task is added by the Coordinator 110 during Plan Configuration 110, with the result that a Notification process 113 would send an email to appropriate roles in CM Feedback 117, such as Approver 114, Reviewer 115, Implementation Team 116 and Coordinator 108, informing the users who represent those roles of configuration change information such as, but not limited to, the new version, the time of change and including the difference in the configuration between the prior and current version.

In accordance with the embodiment of FIG. 1A, a final component of CM process is CM Approval 122, where in Approve status 123 module where approval is sought and received, after which the configuration status becomes Approved. Notification may be made upon approval 123 completion and again upon Implementation instructions 124 completion to the typical roles of Coordinator 108, Approver 114, Reviewer 115, and Implementation Team 116. This triggers the Implementation Schedule Instructions 124 process, which prepares the final configuration for live mode. The CM Approval 122 inputs into the LM Real-time Task Management process.

In accordance with the embodiment of FIG. 1B, Live Mode LM is divided into two components to facilitate description, LM Real-time Task Management 125 and LM Real-time Data Update 130. Within 125, LM Start 126 is a module which changes the status of the implementation to live mode in accordance with timing set in the CM process and OIR process. For instance, CM could specify that Live Mode starts after approval and one week prior to the first task. Notification is sent to all Coordinators 108 and Implementation Team 117 upon change of status to Live Mode. During implementation the Implementation Team 117 and Coordinator are engaged to start real-time implementation, following the configured plan. Real-time Decision 127 is the module where decisions are made in real-time according to configuration set up to the point of approval in FIG. 1A and actual time and status of tasks and implementation. In addition to configuration rules incorporating OIR 104, decisions in real-time may be driven by, for instance, actual time, actual status of task, actual status of configuration, actual result of escalation, and request for workaround during escalation, drop-dead time threshold being reached.

Drop-dead time and drop-dead time thresholds are an elements in both the configuration and the live mode of this embodiment of the invention. If a drop-dead time is configured to be eight AM on a particular date, the drop-dead threshold may be the drop-dead time, minus the time required to complete the rollback, workaround or other actions required once the drop-dead threshold is reached, as per the configuration rules. In a computerized embodiment of this invention, in Live Mode 125, automated adjustment to threshold may be made, as actual time of task completion relative to the drop-dead time are actualized. Similarly, in a computerized embodiment, during configuration 110, the planned threshold would be adjusted as changes are made such as but not limited to, tasks being added, configuration being changed, and planned timing entered.

In the computer system embodiment of this invention, notification of LM start to all relevant roles would be automated, as would the Real-time Decision 127. The automation of 127 would include automatic notification of status and start of next action once a prior action was completed. Status, decisions and other statistical data would be stored in a central data store. That, together with the actual system time, centrally stored Configuration and OIR data would drive decision. A sample decision scenario in such a system would be, but is not limited to, the following: A decision is made automatically in real-time to begin a task in real-time. A notification is send via concurrent sms and email to user1, who is a member of the implementation team. The configuration rules state that the tolerance for task acceptance is five minutes, and the coordinator will be prompted to follow up user1 with a phone call after five minutes has elapsed. This prompt is not given, because within two minutes, User1 marks the tasks as acknowledged via sms using their login and password. User1 beings the task. The estimated length for completion is thirty minutes. The warning tolerance is configured to five minutes prior to planned completion. Escalation tolerance is thirty-five minutes. At twenty-five minutes, the task is not yet marked as completed, so a notification via email, online and sms is sent to both the coordinator and user1 as per configured rules. The user chats online with the coordinator and other team members simultaneously to inform them of an unexpected issue which is not covered in the known risk scenarios. Prior to the automated notification at thirty-five minutes for escalation, the coordinator prompts the escalation ahead of time. All escalation parties in the implementation are notified by sms and are given ten minutes to respond before further action is prompted. All parties respond within the timing period and the coordinator acknowledges the start of the escalation process.

Real-time Decision 127 module interacts with Task Update 128 module, where the task update partially determines the next decision in 127. The task update includes but is not limited to: update of task success status, update of task completion status, update of task timing, update of task risk and issue status. This is checked against the configuration rules for decisions in real-time. Notification task place when an actual event takes place and the configuration specifies notification. Concurrently, in LM Real-time Data Update 130 process, Live Statistics 131 module gathers information to the granularity and inclusion of detail specified in the OIR 104 process of AM 102 process. This data may be used for, the use is not limited to: live reports during run time, post-implementation mode 134 process reports 138 including lessons learned 139, and statistics based recommendations 119. In a computer system embodiment of this invention, the Live Statistics 131 would be an automated process running the background to Real-time Decision (which would also be automated) 127, gathering information into a central data store.

Configuration Item Update 132 module, in this embodiment, performs real-time update of the configuration items associated with the implementation. For instance, if a task success status is ‘failed’ or completion status is ‘incomplete’, and then the configuration item associated with that task would be marked accordingly. If, for example, a task is completed successfully, the configuration item is marked as successfully updated and an automated update of configuration details would take place. This information is stored in a central data store and can be used by CMDB Update 135 process for update of the configuration management database, which is the central store if information regarding configuration items. Note here that the database need not be electronic, but can take any form of data store including paper version. In one computer system embodiment of the invention, it may be possible to have automated real-time update of the configuration item in 132, which, after the implementation is complete, can automatically update data in the electronic CMDB.

Real-time Status Update 131 module works in conjunction with Real-time Decision 127 and Task Update 128 to provide update of implementation status and all components of the implementation as decisions are made, and this data is centrally stored. For instance, approval for completion of the implementation can take place, where appropriate Approval is provided for completion from members of the Implementation Team 117, and which, once granted, changes the mode of the implementation from LM 125, 130 to Post Implementation Mode 134.

In accordance with the embodiment of FIG. 1B, Post Implementation Mode 134 is a process which may be entered once the implementation is approved for completion according to the Configuration rules. In this mode, there is an update of the Configuration Management Database 135 module updates the central store which contains description and links between configuration items based on successful update during implementation. Recommendation Data Store 137 module gathers real-time statistics and stores recommendation data based on OIR 104 configuration. Statistics Report 138 module is the final product of live statistics gathering 131 where a final report of the implementation is delivered. In the computer system embodiment of this invention, the statistics report may include, but is not limited to, include all timing for all tasks, all decisions made, all task statuses, task tolerances and whether they were exceeded, whether and when escalation policy was enacted, any workaround tasks or rollback tasks, whether drop-dead time was reached and if so, at what point in time. The granularity and inclusions are decided by the OIR. The notification can be made on all reports, including this report.

Cost Report 136 is the final cost report for the implementation, based on rules around inclusion specified in OIR 104 and CM 110. The report contains information about the planned against actual cost of the implementation overall, and may be broken up by resource, task, configuration item, time interval, and any other item in the implementation. In one computer system embodiment of this invention, the cost report would automatically calculate for instance, but not limited to, time per resource to compete tasks, include supplied configuration item costs, to combine into an overall or broken down implementation cost. This data could be used to compare against the original planned cost for the implementation, with calculation done on, for example but not limited to, ratio of planned cost to actual cost, difference in planned versus actual, planned and/or actual cost comparison with other implementations of similar priority or complexity. The Lessons Learned Report 136 module is one where statistical data, issues and risk information may be combined together with a post-implementation review to provide a report on root cause of issues, cost of issues, time and other impact of issues, resources used to resolve issues, actions to resolve, recommendations for future improvements in implementation. The output is a report with recommended actions. These actions may be allocated to Owner role 140 for acting on recommendations that are an output of the lessons learned. This completed the typical sample implementation cycle of embodiment of this invention shown in FIG. 1A and FIG. 1B.

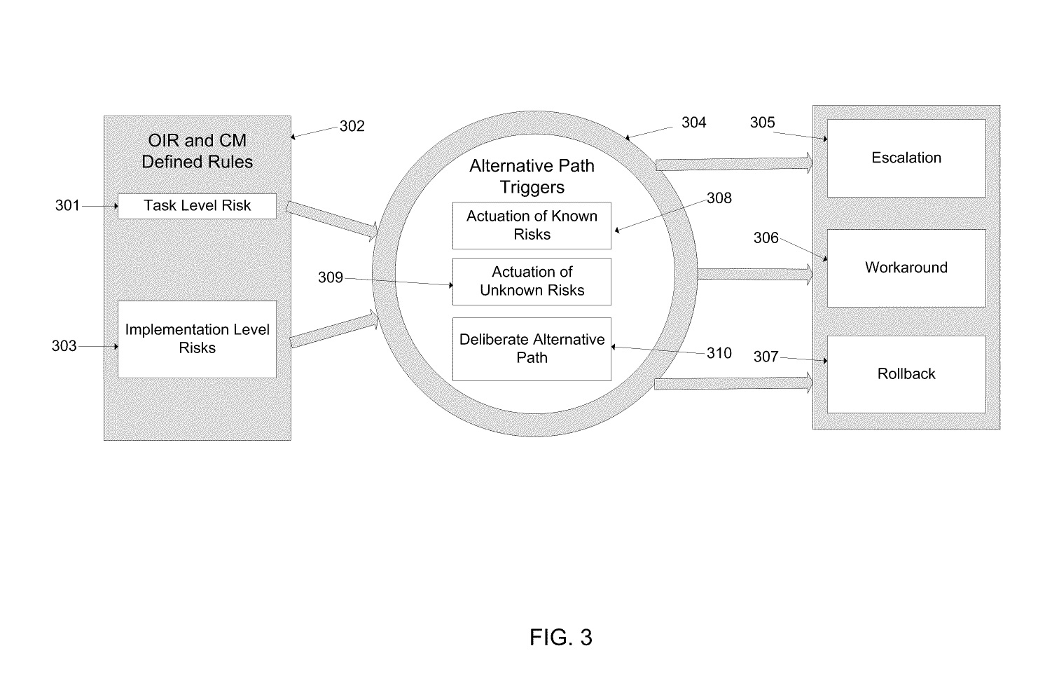

In some embodiments of this invention, alternative implementation path may be triggered by certain conditions as demonstrated in FIG. 3. An alternative implementation path is where the planned implementation is approved for alteration in real-time after the start of LM 125. Beginning with OIR 104 and then CM 110 in the diagram represented as OIR and CM Defined Rules 302 process, configuration rules are set for which alternative implementation path are acceptable, and under what circumstances. The possible alternative implementation paths include but are not limited to: Escalation 305, where a particular sub-group of the implementation team role made decisions on next actions, Workaround 306, where alternative steps are followed, or Rollback 307, where steps to remove certain actions are reversed from completed tasks.

To trigger alternative implementation paths, OIR and CM configuration interact with actual events in the implementation such as, but not limited to, timing, risk actuation, or task success status, to trigger alternative implementation paths. Task Level Risk 301 configuration process, during Configuration mode 110 and/or OIR 104, is where task level rules are set to determine when alternative implementation paths are set. Examples of such task level configuration, include but are not limited to actuation of risks, or tolerance being exceeded for completion of a particular task, or for all tasks, or if there is a failure of a certain task type such as a Checkpoint task (where all tasks to a certain point in time are evaluated for overall success to that point in the implementation). An implementation level risk 303 is a process for setting configuration to allow alternative path the implementation overall. One such implementation level configuration would be an alternative path if the overall drop-dead time is reached for the implementation. The configuration process 110 includes a detailed risk log, including risk description, allocation to task to implementation overall, impact estimation in terms of time, resources and cost, and non-tangible impact such as impact to business. Alternative paths can be triggered by these risks actuating. Cost consideration may be a factor in planning alternative path action. For instance, it may cost less to perform workaround tasks than rollback so this may be factored in during configuration rules setting.

In accordance with the embodiment of FIG. 3, OIR and CM Defined. Rules 302 interacts with Actuation of Known and Unknown Risks 304 to produce alternative implementation paths. Known risks are ones which are planned for prior to the LM Start 125. In such cases it is possible to create alternative implementation steps in advance, for example, but not limited to, a Workaround 306. One such example may be: if the OIR 104 configuration states that whenever a risk actuates for a task and becomes an issue, a workaround should be actioned after approval through the escalation process. In CM mode, it may be mandatory to include workaround tasks for all task risks according to OIR 104. In the event that in Live Mode, a risk eventuates for a particular task, a real-time decision 127 prompt to escalation, where all relevant contact parties are notified, and subsequently, the workaround steps would be started and seen through until all workaround tasks are completed, after which the focus would return to the original implementation tasks. Another example may be that in CM mode 110, a rule is put where if the implementation drop-dead time is reached before certain tasks are marked as successfully completed, there should be immediate rollback without escalation. It is assumed that OIR rules do not prevent this configuration in 110. The rollback actions would be planned out in advance for this scenario. In such as case, if after LM Start 126, drop-dead time was actually reached without successful completion of certain tasks specified in CM 110, then 127 real-time decision process would prompt at that particular preconfigured rollback group of tasks.

There may be other situations, in accordance with 304, where the risks are unknown and the alternative path cannot be planned in advance. In such cases, the OIR 104 and CM 110 would determine which of the following processes, Escalation 305, Workaround 306, or Rollback 307, would take place, in a similar way to that in known risks. An example of an unknown risk actuating into an issue in real-time after LM Start 126, would be where an issue occurs with a task for which none of the preplanned workarounds or other alternative path scenarios apply. In such a case, the OIR and CM rules may determine that an escalation is required, for instance. The escalation policy set in OIR and CM may dictate that workaround steps may be created, and started after being approved by the escalation Implementation Team role.

There may be other situations, where according to OIR 104 and CM 110, a Coordinator role may choose to take an alternate implementation path at their discretion, according to 310, during the implementation. It should also be noted, that it is possible to move between the various alternative implementation paths. For instance, an escalation may lead to a workaround, which may lead to a rollback, or any combination of such paths the OIR 104 and CM 110 allows.

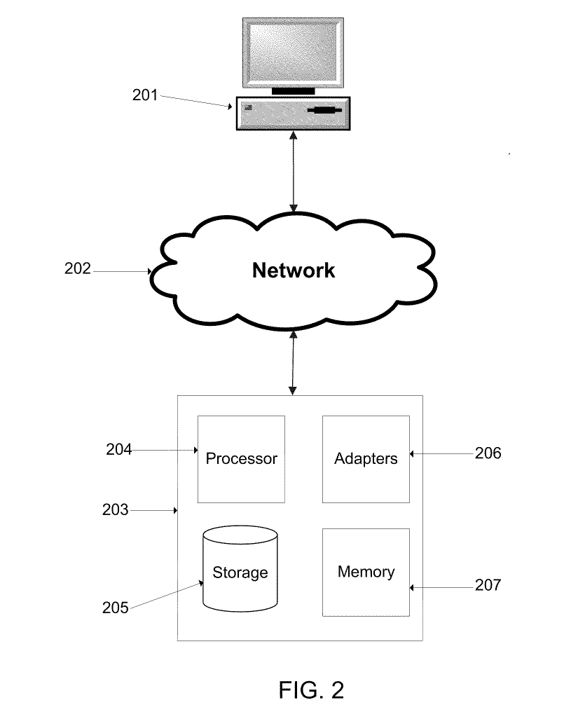

FIG. 2 illustrates hardware used in an example computer implemented embodiment of the invention. It shows an example when a network is used. The network here referenced can be an internal corporate network (intranet) or any network connection between remote users such us internet or width aria network. The system of FIG. 2 consist of computing platform 203 and is controlled by a processor, 204, which works as central processing unit (CPU). The computer platform include number of different types of memory, 207, such as read only memory (ROM), random access memory (RAM). There is a number of communication, interface and general purpose adaptors 206 and at least one of the adaptors used for connection to the network 202. Computer program code instructions for implementing necessary

RTI commands are stored on a storage device 205. When the system is running, the instructions for RTI are at least in part loaded into memory and executed by CPU.

Various type of general purpose computer systems available and could be used as computing platform 203. As illustrated in FIG. 2, the functions of the invention can be implemented at least in part on a stand-alone system such as a personal computer when used by a small business or implemented using a network sever and/or web server that can be accessed from a remote workstation or personal computer 201. As the system and method of this invention can include on demand self-service, broad network access, resource pooling, rapid elasticity, and measured service, which facilitates cloud computer embodiment of the invention.

What is claimed is:

1. A method for managing implementation comprising real-time implementation decisions based on configuration rules and real-time events.

2. A method according to claim 1, wherein implementation management contains:
pre-configured implementation rules interacting with real-time implementation events;
organization-wide implementation rules which determine prerequisite minimum configuration driving real-time decisions across all implementations of said organization;
implementation configuration rules which determine real-time decisions for an individual implementation;
managing alternate courses of action based on configuration rules and real-time implementation triggers;
managing communication across implementation roles throughout the implementation process;
determining overall implementation window, determining individual task timing;
providing recommended configuration rules based on historical implementation information;
defining tolerances for task completion;
defining tolerances for implementation completion;
managing implementation continuous improvement process;
identifying the latest time by which an implementation must be completed based on task and implementation input data;
determining the time by which alternative implementation actions are required to begin in order to avoid overrunning the total allowable time window;
capturing, and reporting on, implementation statistics;
prioritising implementation based on organization-wide criteria;
suggesting implementation dates based on organization-wide criteria;
integrating the configuration management database with the implementation process;
updating and managing of implementation item information throughout the implementation relative to original information depending on implementation and real-time events;
automating configuration management database update with successfully implemented implementation items;
risk management at task and implementation level;
cost tracking and reporting throughout the implementation;
real-time implementation cost tracking;
review and verification process for implementation configuration;
automated real-time implementation decision control based on configuration;
managing, incorporating and reporting on lessons learned from the implementation;
allocating ownership of post-implementation recommendations, integrated with implementation management;
integrating all of the above components of the invention in a computer system.

3. A method according to claim 1, wherein the real-time decisions are based on an real-time statistical on current implementation data and historical implementation data, the statistics containing all prior decisions, the basis for those decisions, configuration related to those decisions, and timing. The depth of data and type of data gathered in said statistics is configurable.

4. A method according to claim 1, wherein software enables multiple concurrent users across one or multiple time-zones to participate in an implementation, the users having defined roles which limit access and function.

5. A method according to claim 1, wherein organization-wide implementation configuration rules which determine prerequisite minimum configuration driving real-time decisions across all implementations of an organization.

6. A method according to claim 5, wherein organization-wide implementation configuration rules are based on department and/or category of implementation.

7. A method according to claim 1, wherein implementation configuration rules determine real-time decisions for an individual implementation.

8. A method according to claim 7, wherein organization-wide implementation configuration rules are set minimal rules which form the basis for the said individual implementation configuration rules.

9. A method according to claim 1, wherein managing alternate implementation path in an implementation is based on configuration rules and real-time implementation events.

10. A method of claim 9, where an alternate implementation path is the initiation of at least one of the following: a workaround, an escalation, or a rollback. A workaround tasks are created during configuration or in real-time to deal with situations where an issue diverts the implementation from the expected path. An escalation is where communication with selected parties is initiated to decide further action once an implementation diverts from the expected path. A rollback is where there is a decision to under a part of or the entire implementation.

11. A method according to claim 9, wherein alternate implementation paths are based on decisions in real-time based on configuration and real-time events.

12. A method according to claim 9, wherein alternate implementation paths are further based on cost and risk information associated with a task and with the implementation overall.

13. A method according to claim 1, wherein decisions are managing through communication across implementation roles throughout the implementation process and in real-time.

14. A method according to claim 13, wherein communication comprises notifications which can take various forms simultaneously and where said notifications can be sent to various users simultaneously.

15. A method according to claim 13, wherein notifications can be initiated manually by a user, or automatically via a decision in the system.

16. A method according to claim 13, wherein notifications are made from a user to the computer system, by the computer system to users, or between two users.

17. A method according to claim 13, wherein notifications can be made through any type of electronic or manual signal.

18. A method according to claim 1, wherein decisions can be initiated both manually by users with specified roles, or automatically by the system, and both manually and automatically initiated decisions can be made in the same implementation. Configuration determines what level of manual or automated decision control is used for an implementation and which roles can make which decisions.

19. A method according to claim 1, wherein the system further determines an overall, or individual task level, implementation window.

20. A method according to claim 1, wherein the system provides recommended configuration rules based on historical implementation information.

21. A method according to claim 1, wherein the system provides recommended decisions in real-time based on historical decision statistics.

22. A method according to claim 1, wherein the system provides recommended alternative implementation path decisions in real-time based on historical decision statistics.

23. A method according to claim 1, wherein implementation decision control is based on task and overall implementation tolerance, containing:
setting multiple possible custom tolerances per task or per implementation;
custom tolerance setting is based on real-time task or implementation status, including timing, interacting with configuration for that implementation;
task level and implementation level tolerances based on planned versus actual implementation timing, which lead to any combination of subsequent implementation tasks, actions, or notifications;
task level and implementation level tolerances, based on success status, which lead to a subsequent implementation tasks and/or actions and/or alerts;
task level and implementation level tolerances, based on completion status, which lead to a subsequent implementation tasks and/or actions and/or alerts.

24. A method according to claim 23, wherein tolerance is either time-based or status-based.

25. A method according to claim 1, which further contains managing implementation continuous improvement process through lessons learned being applied to future implementations.

26. A method according to claim 1, which further contains determining the time by which alternative implementation actions are required to begin in order to avoid overrunning the total allowable time window.

27. A method according to claim 1, which further contains integrating the configuration management database with the implementation process.

28. A method according to claim 1, which further contains updating and managing of implementation item information throughout the implementation relative to original information depending on implementation and real-time events.

29. A method according to claim 1, which further contains automating configuration management database update with information about implementation items based on configuration rules and real-time events.

30. A method according to claim 1, which further contains review and verification process for implementation configuration.

31. A method according to claim 30, wherein said verification process for implementation configuration contains: automated simulated trial implementation of a portion of an entire implementation. The components of the implementation to be included in the simulation are customizable.

32. A method according to claim 1 that produces and stores a log file of the implementation, the details of which are configurable.

33. A method according to claim 1, which further contains provision for multiple, simultaneously remote implementation management.

34. A method according to claim 2, wherein a lessons learned database comprises:
implementation timing statistics;
actual versus planned implementation timing;
actuated risks, or risks which become issues;
all listed issues;
issues being captured in real-time;
estimated impact of implementation issues or opportunities in terms of any combination of schedule, resources, or cost;
root cause of implementation issues and opportunities;
lessons learned based on implementation issues and opportunities;
recommendations based on implementation issues and opportunities.
use of stored statistics real-time to automatically prompt recommended actions and/or automatic notifications and/or automatic real-time implementation decisions.

35. A method according to claim 1, wherein implementation configuration can be copied at any stage or mode in the implementation process, into a new implementation configuration, where the detail of copying, in terms of component inclusion, is adjustable.

36. A method according to claim 1, further comprising an implementation and task level risk assessment. In said risk assessment risk probability, risk impact, impact cost, mitigation cost, mitigation resources and timing information are included. The risks being realised drive decisions in real-time and can lead to alternate implementation paths.

37. A method according to claim 1, further comprising cost assessment at task and overall implementation level which provides a detailed costing of the implementation and which can be used to drive decisions in real-time.

38. A method according to claim 1, which provides version control for implementation configuration, where any changes are tracked, and the configuration label is altered to indicate a changed version.

39. A method according to claim 1, where implementation configuration is reviewed and approved by specified roles.

40. A method according to claim 1, wherein implementation configuration can be copied from prior saved implementations, with the level of detail copied being customizable.

41. A method according to claim 1, wherein implementations can be prioritized, the prioritizations being based on ranking against other implementations according to an organization-wise, or department-wide, implementation ranking criteria. The prioritization method contains multiple conditions for ranking and those conditions are weighted against other conditions. For a particular implementation, a total ranking score is given based on answering to the conditions, and that score is ranked against other implementation scores.

42. A method according to claim 41, wherein implementation prioritization is the driver for implementation date recommendations along with implementation-specific date drivers and date drivers external to the implementation.

43. A method according to claim 1, wherein implementation level drop-dead time is calculated by taking into consideration overall implementation window and timing of each task, including any alternate implementation path tasks.

44. A method according to claim 43, wherein the drop-dead time is adjusted in real-time according to configuration rules.

45. A method according to claim 1, task level drop-dead time automatic calculation taking into consideration the window for a particular task and the actual timing of the task.

46. A method according to claim 43, wherein drop-dead time threshold sets one or multiple warnings prior to a drop-dead time for either task or implementation level.

47. A method according to claim 46, wherein drop-dead time threshold is adjusted in real-time according to configuration rules.

48. A method according to claim 1, further comprising import from external software implementation configuration.

49. A method according to claim 1, wherein task timing tolerance leads to real-time decisions and alerts, with multiple levels of tolerance possible per task.

50. A computer program product of claim 1, comprising a computer readable medium with a computer program embodied therein for facilitation of implementation management, the computer program comprising:
instructions for setting and using implementation configuration;
instructions for real-time decisions in live implementations;
instructions for setting and using organizational level implementation rule sets;
instructions for lessons learned;
instructions for using historical data
instructions for implementation reports;
instructions for cost tracking and reporting;
instructions for risk management;
instructions for implementation prioritization;
instructions for implementation issue management;
instructions for verification of implementation;
instructions for communication management;
instructions for real-time recommendations for decisions.
instructions for configuration recommendations;

51. A computer program product of claim 1 wherein the computer program further comprises:
instructions for implementation risk management;
instructions for implementation tolerance settings;
instructions for implementation of workaround;
instructions for implementation escalation;
instructions for implementation rollback.

52. A computer program product of claim 48, wherein the computer program further comprises instruction for determining optimal real-time implementation path in terms of cost, resources, time.

53. A computer program product of claim 48, wherein the computer program further comprises: instructions for real-time decisions for and implementation based on said implementation configuration.

54. A method according to claim 1, which has user pay access to an online version of the said method, on a hosted site.
